(19) United States
(12) Patent Application Publication
(10) Pub. No.: US 2026/0070047 A1
(43) Pub. Date: Mar. 12, 2026

(54) DUAL-FIBER ION-EXCHANGE MEMBRANES

(71) Applicant: UCHICAGO ARGONNE, LLC, Chicago, IL (US)

(72) Inventors: Yuepeng ZHANG, Naperville, IL (US); Jungkuk Lee, Bolingbrook, IL (US); Feng Gao, Bolingbrook, IL (US)

(73) Assignee: UCHICAGO ARGONNE, LLC, Chicago, IL (US)

(21) Appl. No.: 19/319,334

(22) Filed: Sep. 4, 2025

Related U.S. Application Data
(60) Provisional application No. 63/691,779, filed on Sep. 6, 2024.

(51) Int. Cl. B01J 39/18; B01D 69/12; B01D 71/28; B01D 71/42; B01D 71/52; D04H 1/728

(52) U.S. Cl. CPC B01J 39/18; B01D 69/1214; B01D 71/281; B01D 71/421; B01D 71/5211; D04H 1/728

(57) ABSTRACT

Described herein are articles of manufacture comprising intertwined cation-conductive polymer fibers such as cross-linked sulfonated polystyrene (c-SPS) fibers and conductive nanoparticle-embedded hydrophilic water-insoluble polymer fibers such as PAN fibers in which the conductive nanoparticles are embedded within the hydrophilic water-insoluble polymer fibers. Also described are dense ion-exchange membranes formed from the articles of manufacture by hot-pressing the intertwined fibers to form a dense (i.e., substantially non-porous) membrane. The articles of manufacture are prepared by co-electrospinning cationic conductive polymer fibers such as SPS fibers and conductive nanoparticle-embedded hydrophilic water-insoluble polymer fibers such as PAN fibers from separate nozzles into the same collector, which substantially uniformly intertwines the fibers. The SPS fibers are then crosslinked with a suitable crosslinking agent, such as polyethylene oxide (PEO; also known as polyoxyethylene), poly(vinyl alcohol) or divinylbenzene.

### CROSS-REFERENCE TO RELATED APPLICATIONS

This application claims the benefit of U.S. Provisional Application Ser. No. 63/691,779 filed on Sep. 6, 2024, which is incorporated herein by reference in its entirety.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to mixed nanofiber materials and to ion-exchange membranes formed therefrom.

### BACKGROUND

Effective, efficient, profitable, and deployable water desalination and valorization is paramount to American society and economy. Reverse osmosis (RO) technology has been dominating water desalination owing to its high salt rejection capability. The RO, however, consumes a great deal of energy during pressure-driven filtration, accounting for 50% of the overall water treatment process cost. It also has a high-water rejection rate of up to 70%. Recently, membrane electrodialysis (ED), an electrical field driven separation technology, has started to play an important role in water treatment, especially wastewater recovery. In contrast to RO, ED relies on the transmembrane transport of ions to achieve water-salt separation, which often shows lower energy consumption and a higher water recovery rate, making ED a suitable RO downstream treatment step for further concentrating RO brines to enable zero liquid discharge (ZLD). Multiple industrial wastewater treatment uses have been reported for membrane ED-based systems, including oil and gas produced waters, wastewaters from refineries and petrochemical industries, and drainage wastewaters from coal mining and power plants.

NAFION membranes from DuPont, FLEMION membranes from Asahi Glass, and NEOSEPTA membranes from ASTOM are the current commercially available cation-exchange membranes (CEM) commonly used for membrane ED. These CEMs have a relatively high ionic conductivity and relatively good chemical and mechanical stability. For example, NAFION 117 membrane reportedly has ion-exchange capacity of 0.9 meq g⁻¹, ^{a} swelling degree of 13%, and a Na⁺ conductivity of 26.5 mS/cm. The NEOSEPTA CMX membrane reportedly has and ion-exchange capacity 1.64 meq g⁻¹, a swelling degree of 21.5%, and a Na⁺ conductivity of 6.7 mS cm⁻¹. A challenge associated with these commercial CEM membranes are high prices in the range of $200/m²-500/m². In addition, the perfluorinated CEM also causes per- and polyfluoroalkyl substance (PFAS) contamination in water. Hence, low-cost and environmentally benign CEMs are needed. The ion exchange membranes, articles of manufacture, and methods described herein address these needs.

### SUMMARY

Dual-fiber electrospun membranes are disclosed herein to replace expensive commercial ion-exchange membranes. In particular, low-cost, fluorine-free hydrocarbon electromembranes are disclosed, which comprise dual-fiber electromembranes made of stable, cross-linked fluorine-free, cation-conductive, hydrocarbon polymers (c-FF-CCP) such as cross-linked sulfonated polystyrene (c-SPS) and conductive nanoparticle embedded hydrophilic water-insoluble polymers (cNP-HWIP) such as polyacrylonitrile (PAN) fibers containing embedded electron-conductive nanoparticles. The c-SPS portion of the membrane has a high ion-exchange capacity (IEC) comparable with current state-of-the-art NAFION CEMs. The addition of conductive cNP-HWIP fibers, such as conductive nanoparticle-embedded polyacrylonitrile (cNP-PAN) increases electrical conductivity and ED energy efficiency. Well-intermixed ionic conductive and electrically conductive domains, in microscale, are achieved through the intertwined dual-fiber design, leading to good transport properties. Membrane water uptake and mechanical strength can be fine-tuned by adjusting the volume ratio between the c-FF-CCP (e.g., c-SPS) and the cNP-HWIP (e.g., cNP-PAN) during electrospinning processing. The dual-fiber electromembranes described herein have low materials costs and can be produced with a scalable continuous manufacturing process.

The following non-limiting embodiments are provided to illustrate certain aspects and features of the articles of manufacture, ion-exchange membranes and methods described herein.

Embodiment 1 is an article of manufacture comprising c-FF-CCP fibers intertwined with cNP-HWIP fibers.

Embodiment 2 is the article of manufacture of embodiment 1, wherein the c-FF-CCP fibers are cross-linked sulfonated polystyrene (c-SPS) fibers; and the cNP-HWIP fibers are cNP-PAN fibers.

Embodiment 3 is the article of manufacture of embodiment 2, wherein the c-SPS fibers are crosslinked by one or more crosslinking agents selected from the group consisting of polyoxyethylene, poly(vinyl alcohol), and divinylbenzene.

Embodiment 4 is the article of manufacture of embodiment 2, wherein the c-SPS fibers are crosslinked by polyoxyethylene groups bonded to sulfonate groups of the sulfonated polystyrene as sulfonate esters.

Embodiment 5 is the article of manufacture of any one of embodiments 1 to 4, wherein the hydrophilic water-insoluble polymer is one or more polymer selected from the group consisting of PAN, an acrylic polymer, an epoxy polymer, polyethylene, polystyrene, polyvinylchloride, polydimethylsiloxane, a polyester, poly(2-hydroxyethyl methacrylate), a polyurethane, an amphiphilic block copolymer that contains hydrophobic and hydrophilic units, poly(N-isopropylacrylamide-co-spiropyran acrylate), a co-polymer of 2-methacryloyloxyethyl phosphorylcholine (MPC) and n-dodecyl methacrylate, a hydrogel, a three-dimensionally (3D) crosslinked polymer, and a supramolecular complex formed between a block co-polymer and a hydrogel;
wherein each hydrogel independently comprises hydrophilic polymer chains that are crosslinked either physically, chemically, or via polymerization; and
wherein the 3D crosslinked polymer optionally is selected from the group consisting of cross-linked gum Arabic, cross-linked PEG, cross-linked hydroxyethyl cellulose, cross-linked carboxymethyl cellulose, cross-linked hydroxypropyl methylcellulose, cross-linked hydroxypropyl cellulose, cross-linked starch, cross-linked PVA, cross-linked sterculia gum, cross-linked polyacrylamide, and cross-linked chitosan; and the supramolecular complex formed between a block co-polymer and a hydrogel optionally is a supramolecular complex of poly(N-vinylpyrrolidone)-b-poly(oligo ethylene glycol methacrylate) combined with alpha-cyclodextrin (α-CD).

Embodiment 6 is the article of manufacture of any one of embodiments 1 and 5, wherein the c-FF-CCP is selected from the group consisting of c-SPS and an ionic conductive salt-containing cross-linked PEO;
wherein the ionic conductive salt-containing cross-linked PEO optionally is methacrylate-appended PEO comprising a salt selected from sodium pentacyanopropenide (NaPCPI), sodium 2,3,4,5-tetracyanopirolate (NaTCP), sodium 2,4,5-tricyanoimidazolate (NaTIM), and a potassium ion source; and wherein the potassium ion source optionally is KBPh₄.

Embodiment 7 is the article of manufacture of any one of embodiments 1 to 6, wherein the conductive nanoparticles comprise one or more nanoparticle material selected from the group consisting of graphene, reduced graphene oxide, biochar, graphite, conductive carbon, carbon nanotubes, and MXene.

Embodiment 8 is the article of manufacture of any one of embodiments 1 to 7, wherein the cNP-HWIP fibers (e.g., cNP-PAN fibers) comprise about 1 to about 40 percent by weight of the conductive nanoparticles, based on the weight of the hydrophilic water-insoluble polymer.

Embodiment 9, is the article of manufacture of embodiment any one of embodiments 1 to 8, wherein the c-FF-CCP fibers and cNP-HWIP fibers are formed and intertwined by simultaneously electrospinning the fibers from separate polymer solutions comprising (a) fluorine-free cation-conductive polymer (e.g., SPS) and a cross-linking agent, and (b) a hydrophilic water-insoluble polymer (e.g., PAN) and electron-conductive nanoparticles; the solutions being simultaneously electrospun through separate electrospinning nozzles onto a revolving grounded or negatively-charged drum, followed by crosslinking the hydrophilic water-insoluble polymer with the included crosslinking agent.

Embodiment 10 is the article of manufacture of any one of embodiments 1 to 9, wherein the c-FF-CCP fibers have an average fiber diameter in the range of about 0.05 μm to about 10 μm.

Embodiment 11 is the article of manufacture of any one of embodiments 1 to 10, wherein the cNP-HWIP fibers have an average fiber diameter in the range of about 0.05 μm to about 10 μm.

Embodiment 12 is the article of manufacture of any one of embodiments 1 to 11, having a respective weight ratio of the c-FF-CCP fibers to the cNP-HWIP fibers of about 95:5 to about 50:50.

Embodiment 13 is an ion-exchange membrane comprising the article of manufacture of any one of embodiments 1 to 12, wherein c-FF-CCP fibers and the cNP-HWIP fibers are fused together to form a dense ion-exchange membrane.

Embodiment 14 is the ion-exchange membrane of embodiment 13, wherein the dense ion-exchange membrane has a thickness in the range of about 5 μm to about 500 μm.

Embodiment 15 is an article of manufacture comprising cross-linked sulfonated polystyrene (c-SPS) fibers intertwined with conductive nanoparticle-embedded polyacrylonitrile (cNP-PAN) fibers.

Embodiment 16 is the article of manufacture of embodiment 15, wherein the c-SPS fibers are crosslinked by one or more crosslinking moiety selected from the group consisting of polyoxyethylene groups and poly (vinyl alcohol) groups bonded to sulfonate groups of the sulfonated polystyrene.

Embodiment 17 is the article of manufacture of embodiment 15 or embodiment 16, wherein the c-SPS fibers are crosslinked by polyoxyethylene groups or poly (vinyl alcohol) groups bonded to sulfonate groups of the sulfonated polystyrene.

Embodiment 18 is the article of manufacture of any one of embodiments 15 to 17, wherein the conductive nanoparticles comprise one or more nanoparticle material selected from the group consisting of graphene, reduced graphene oxide, biochar, graphite, conductive carbon, carbon nanotubes, and MXene.

Embodiment 19 is the article of manufacture of any one of embodiments 15 to 18, wherein the cNP-PAN fibers comprise about 1 to about 40 percent by weight of the conductive nanoparticles embedded therein, based on the weight of PAN.

Embodiment 20 is the article of manufacture of any one of embodiments 15 to 19, wherein the c-SPS fibers and PAN fibers are formed and intertwined by simultaneous electrospinning the fibers from separate polymer solutions comprising (a) SPS and a cross linking agent, and (b) PAN and conductive nanoparticles; the solutions being electrospun through separate electrospinning nozzles onto a revolving grounded or negatively charged substrate, followed by crosslinking the SPS with the included crosslinking agent.

Embodiment 21 is the article of manufacture of any one of embodiments 15 to 20, wherein the c-SPS fibers have an average fiber diameter in the range of about 0.05 μm to about 10 μm.

Embodiment 22 is the article of manufacture of any one of embodiments 15 to 21, wherein the cNP-PAN fibers have an average fiber diameter in the range of about 0.05 μm to about 10 μm.

Embodiment 23 is the article of manufacture of any one of embodiments 15 to 22, having a respective weight ratio of c-SPS fibers to cNP-PAN fibers of about 95:5 to about 50:50.

Embodiment 24 is an ion-exchange membrane comprising cross-linked sulfonated polystyrene (c-SPS) fibers intertwined with conductive nanoparticle-embedded polyacrylonitrile (cNP-PAN) fibers, wherein c-SPS fibers and the cNP-PAN fibers are fused together to form a dense ion-exchange membrane.

Embodiment 25 is the ion-exchange membrane of embodiment 24, wherein the dense ion-exchange membrane has a thickness in the range of about 5 μm to about 500 μm.

Embodiment 26 is the ion-exchange membrane of embodiment 24 or embodiment 25, wherein the c-SPS fibers are crosslinked by one or more crosslinking moiety selected from the group consisting of polyoxyethylene groups and poly (vinyl alcohol) groups bonded to sulfonate groups of the sulfonated polystyrene.

Embodiment 27 is the ion-exchange membrane of any one of embodiments 24 to 26, wherein the c-SPS fibers are crosslinked by polyoxyethylene groups or poly (vinyl alcohol) groups bonded to sulfonate groups of the sulfonated polystyrene.

Embodiment 28 is the ion-exchange membrane of any one of embodiments 24 to 27, wherein conductive nanoparticles comprise one or more nanoparticle material selected from the group consisting of graphene, reduced graphene oxide, biochar, graphite, conductive carbon, carbon nanotubes, and MXene.

Embodiment 29 is the ion-exchange membrane of any one of embodiments 24 to 28, wherein the c-SPS fibers and cNP-PAN fibers are formed and intertwined by simultaneously electrospinning the fibers from separate polymer solutions comprising (a) SPS and a cross linking agent, and (b) PAN and conductive nanoparticles; the solutions being electrospun through separate electrospinning nozzles onto a revolving grounded or negatively charged drum, followed by crosslinking the SPS with the included crosslinking agent.

Embodiment 30 is the ion-exchange membrane of any one of embodiments 24 to 29, wherein the c-SPS fibers have an average fiber diameter in the range of about 0.05 μm to about 10 μm.

Embodiment 31 is the ion-exchange membrane of any one of embodiments 24 to 30, wherein the cNP-PAN fibers have an average fiber diameter in the range of about 0.05 μm to about 10 μm.

Embodiment 32 is the ion-exchange membrane of any one of embodiments 24 to 31, wherein the cNP-PAN fibers comprise about 1 to about 40 percent by weight of the conductive nanoparticles, based on the weight of the PAN.

Embodiment 33 is the ion-exchange membrane of any one of embodiments 24 to 32, having a respective weight ratio of c-SPS fibers to cNP-PAN fibers of about 95:5 to about 50:50.

Embodiment 34 is a method of preparing the ion-exchange membrane of any one of embodiments 24 to 33, comprising:
(a) simultaneously and separately electrospinning a first solution of sulfonated polystyrene and a crosslinking agent, and a second solution of conductive nanoparticles and polyacrylonitrile onto a grounded or negatively charged substrate (e.g., a revolving drum) from separate nozzles onto the substrate (e.g., the revolving drum), to generate an intertwined mixture of SPS fibers and PAN fibers embedded with the conductive nanoparticles (cNP-PAN fibers);
(b) reacting the SPS with the crosslinking agent within the SPS fibers to form cross-linked SPS (c-SPS) fibers;
(c) recovering the so-formed intertwined c-SPS and cNP-PAN fibers from the substrate; and
(d) hot-pressing the intertwined fibers from step (c) into a dense membrane.

Embodiment 25 is a method of preparing the ion-exchange membrane of any one of embodiments 13 to 23, comprising:
(a) simultaneously and separately electrospinning a first solution of a fluorine-free cation-conductive polymer and a crosslinking agent, and a second solution of electron-conductive nanoparticles and a hydrophilic water-insoluble polymer onto a grounded or negatively charged drum from separate nozzles on opposite sides of the drum, to generate an intertwined mixture of fluorine-free cation-conductive polymer fibers and cNP-HWIP fibers;
(b) reacting the fluorine-free cation-conductive polymer with the crosslinking agent within the fluorine-free cation-conductive polymer fibers to form the c-FF-CCP fibers;
c) recovering the so-formed intertwined c-FF-CCP fibers and the cNP-HWIP fibers from the substrate, and
(d) hot-pressing the intertwined fibers from step (c) into a dense membrane.

### BRIEF DESCRIPTION OF THE DRAWINGS

FIG. 1 provides an illustration of c-SPS-(cNP-PAN) dual-fiber membrane synthesis scaleup and operation: (a) dual-fiber fabrication by multijet rotary electrospinning, followed by (b) crosslinking and densification under hydraulic hot pressing.

FIG. 2 provides a SEM image of graphene-embedded PAN nanofibers (graphene-PAN).

FIG. 3 provides SEM images of (a) porous reduced graphene oxide (rGO) nanoparticle embedded PVDF (rGO-PVDF) membrane; and (b) dense rGO-PVDF fiber membranes after hot-pressing.

FIG. 4 provides a schematic illustration of converting poly(styrenesulfonic acid sodium salt) into poly(styrene sulfonic acid) through ion exchange chromatography.

FIG. 5 provides energy dispersive X-ray spectra associated with SEM (a), and inductively coupled plasma analysis results of poly(styrenesulfonic acid sodium salt) and poly(styrene sulfonic acid) samples (b), before and after ion exchange chromatography.

FIG. 6 provides example electrospinning conditions used to fabricate SPS nanofibers (a), and the SEM images of the formed SPS nanofibers at two different magnifications (b).

### DETAILED DESCRIPTION

A novel conductive nanoparticle-enhanced hydrocarbon-based electromembrane that enables low-cost, energy-efficient brackish water desalination and industry wastewater valorization is disclosed herein. In particular, the electromembranes described herein comprise co-electrospun c-FF-CCP fibers (e.g., crosslinked polystyrene (c-SPS)) and cNP-HWIP fibers (e.g., polyacrylonitrile (PAN) comprising conductive nanoparticles embedded within the PAN fiber component). The co-electrospinning techniques results in a well mixed and intertwined composite of fibers of the two polymer materials. The resulting electrospun product is then densified, e.g., by hot pressing to form a dense membrane. When integrated with recirculated ED processes and high-efficiency solar/wind evaporation such as interfacial photothermal evaporation, the dual-fiber membranes can facilitate zero liquid discharge (ZLD) due to its electric field-driven high separation efficiency.

Electrospinning is a well-known technique for producing polymer microfibers and nanofibers using an electric field to draw charged threads of polymer solutions through a nozzle. Fibers produced by electrospinning can have average diameters ranging from a few tens of nanometers to a few micrometers. In the process, a high voltage is applied to a solution of a polymer in a suitable solvent to draw a droplet of the solution through a fine nozzle, the solution becomes charged, and electrostatic repulsion counteracts the surface tension in the droplet, which consequently stretches. Eventually a stream of liquid emerges from the surface of the droplet. Solvent evaporates from the stream in flight, forming an elongated fiber that thins during flight, which eventually deposits on a grounded or negatively charged collector. The elongation and thinning of the fiber results in uniform fibers with nanometer-scale diameters. In the methods described herein, fibers of an FF-CCP (e.g. SPS) and a cNP-HWIP (e.g., cNP-PAN) are simultaneously formed by simultaneously and separately electrospinning FF-CCP and cNP-HWIP fibers from two different nozzles opposite sides of a grounded or negatively charged substrate (e.g., a spinning drum), which intertwines the FF-CC and cNP-HWIP fibers as they deposit on the substrate. The FF-CCP is then crosslinked, e.g., by adding a cross-linking agent to the combination of mixed fibers, or by adding the cross-linking agent to the FF-CCP before electrospinning.

When polyethylene oxide (PEO) is used as the crosslinker, the PEO is added and the mixture of fibers is heated at a temperature and for a sufficient period of time for hydroxyl groups on either end of a PEO chain to react with groups on the FF-CCP to form the C-FF-CCP (e.g., to cross-link two different sulfonate groups of SPS to form sulfonate esters at each end of the PEO chain, resulting in a crosslink between different SPS chains and/or between different portions of the same SPS chain, depending on where the sulfonate groups reside).

Non-limiting examples of crosslinking agents include PEO, polyvinyl alcohol (PVA) and divinylbenzene. The relative amount of crosslinking agent used can also vary from about 5 to about 50 mol % based on moles of reactive groups on the FF-CCP polymer chains.

Non-limiting examples of conductive nanoparticle (cNP) materials for use in the membranes described herein include graphene, reduced graphene oxide (rGO), biochar, graphite, conductive carbon particles, carbon nanotubes, and MXene nanoparticles. MXenes are two-dimensional inorganic compounds that comprise atomically thin layers of transition metal carbides, nitrides, or carbonitrides, and can be further functionalized by hydrophilic groups. Typically, the nanoparticles have an average particle diameter of about 5 nm to about 500 nm, as determined by scanning electron microscopy (SEM) and dynamic light scattering (DLS).

There are other examples of hydrophilic non-water-soluble polymers in addition to PAN, which can be used to carry cNPs. These polymers include hydrophilic water resistant polymers such as acrylics, epoxies, polyethylene, polystyrene, polyvinylchloride, polydimethylsiloxane, polyesters, poly(2-hydroxyethyl methacrylate), and polyurethanes, amphiphilic block copolymers that contains hydrophobic and hydrophilic units such as poly(N-isopropylacrylamide-co-spiropyran acrylate) and co-polymer of 2-methacryloyloxyethyl phosphorylcholine (MPC) and hydrophobic n-dodecyl methacrylate, hydrogels that are 3D network structures composed of hydrophilic polymer chains crosslinked either physically, chemically, or via polymerization, such as the crosslinked 3D structures of gum Arabic, PEG, hydroxyethyl cellulose, carboxymethyl cellulose, hydroxypropyl methylcellulose, hydroxypropyl cellulose, starch, PVA, sterculia gum, polyacrylamide, and chitosan, as well as supramolecular complex formed between block co-polymer and hydrogel such as poly(N-vinylpyrrolidone)-b-poly(oligo ethylene glycol methacrylate) combined with alpha-cyclodextrin (α-CD).

There are other materials that can be used for fluorine-free ionic conductive membranes, replacing, e.g., c-SPS. Examples include ionic conductive salt containing cross-linked PEO such as poly(ethylene glycol) methacrylate appended PEO with sodium pentacyanopropenide (NaPCPI), sodium 2,3,4,5-tetracyanopirolate (NaTCP)and sodium 2,4,5-tricyanoimidazolate (NaTIM) additives, and crosslinked PEO with potassium ion source like KBPh₄.

Suitable electrospinning solvents for the FF-CCP (e.g., SPS) electrospinning solution include, without limitation, polar aprotic solvents (e.g., dimethyl formamide (DMF), acetone, dimethyl sulfoxide (DMSO) and the like), protic solvents (e.g., methanol, water, tetraethylene glycol dimethyl ether, and the like), and non-polar solvents (e.g. toluene and the like). Suitable electrospinning solvents for the cNP-HWIP (e.g., cNP-PAN) electrospinning solution include, without limitation, polar aprotic solvents (e.g., DMF, dimethylacetamide (DMA), ethylene carbonate, propylene carbonate, tetraethylene glycol dimethyl ether, and the like). The ratio of c-FF-CCP (e.g., c-SPS) to cNP-HWIP (e.g., cNP-PAN) fibers can be varied, e.g., from about 95:5 to about 50:50. Similarly, the concentration of conductive nanoparticles in the cNP-HWIP (e.g., cNP-PAN) fibers can be varied, e.g., from about 1 weight percent (wt %) cNP to about 40 wt % cNP.

The ion-exchange membranes formed from the electrospun fibers can have a thickness in the range of about 5 μm to about 500 μm.

The term “dense membrane” is well known in the separation arts, and refers to a membrane that is non-porous or has no more than nanosized pores, and uses solubility and diffusivity of a substance within the material composing the membrane for separation.

### Synthesis Process

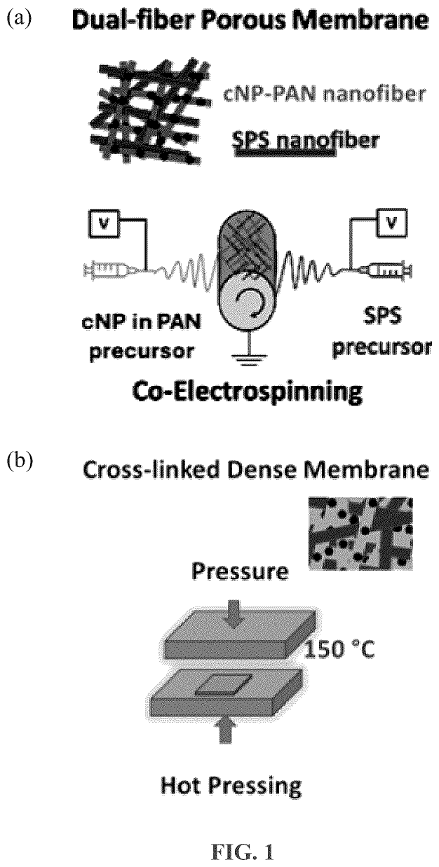

FIG. 1 schematically illustrates a c-SPS-(cNP-PAN) membrane synthesis process, which includes scalable dual-fiber porous membrane fabrication using multijet rotary electrospinning onto a spinning drum, followed by crosslinking the SPS, and densification of the intertwined fibers under hydraulic hot pressing to form a dense ion-exchange membrane.

Electrospinning of SPS nanofiber and crosslinking: The core of the ED process is an ion-exchange membrane (IEM), which can selectively transport cations or anions to separate compartments, achieving desalination and separation. The power of ion transport of an IEM is determined by its ionic conductivity, which is closely related to IEM's ion-exchange capacity (IEC). In the dual-fiber c-SPS-(cNP-PAN) composite cation-exchange membrane (CEM) described herein, SPS nanofibers are the ion-exchange component, benefiting from SO⁻₃ groups as the ion-exchange functionality. The SPS is cross-linked to improve its stability in water. Polyethylene oxide (PEO) can be utilized as a crosslinker, which is included in the electrospinning solution of the SPS. The crosslinking degree of SPS is controlled by adjusting the ratio between SPS and PEO in the precursor. It is noted that too high a crosslinking degree will consume too many SO⁻₃ groups, resulting in a low IEC. Thus, the crosslinking degree is adjusted to ensure both good stability and high IEC of the crosslinked SPS membrane. SPS:PEO ratios typically can be in the range of about 80:20 to about 50:50.

Briefly, to form crosslinked SPS fibers, poly(sodium 4-styrenesulfonate) and PEO of various ratios are dissolved in dimethylformamide (DMF) to from electrospinning precursor solutions, followed by electrospinning and post-spinning thermal treatment at 130° C. for about 8 hours to form sulfonic acid ester between two sulfonate groups on SPS polymer chains and/or different sulfonates on the same SPS chain by forming sulfonate esters between the sulfonate groups and hydroxyl groups on the PEO. X-ray photoelectron spectroscopy (XPS) can be used to investigate bonding information (e.g., S—O—C) between PEO and SPS, and the crosslinking degree. The fabricated c-SPS non-woven structures are hot-pressed at 150° C. to form a solid dense membrane for stability evaluation under an accelerated degradation testing in hot water or in ED under large current densities. In addition to stability, IEC can be tuned to control SPS swelling. SPS has a high level of water uptake due to its SO₃ groups, causing a potential swelling issue. This can deteriorate at high IEC as more charge groups adsorb more water. By tuning IEC through crosslinking, c-SPS membrane swelling can be maintained below 25%.

### Electrospinning of cNP-PAN

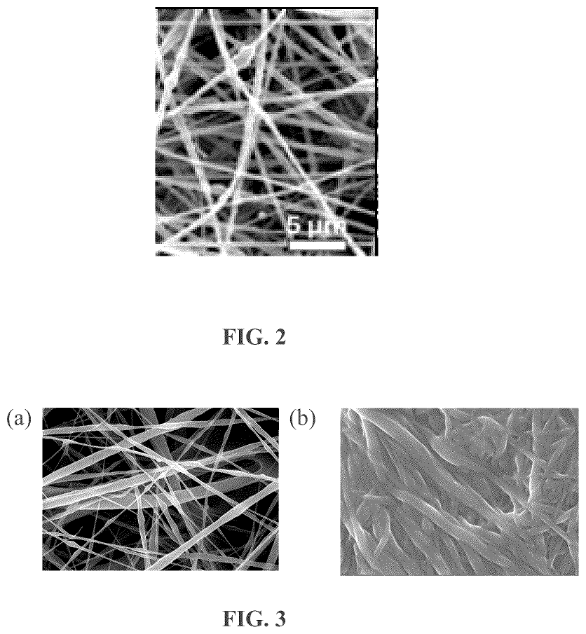

Conductive nanoparticle materials are typically ball-milled to a particle size below about 200 nm, and then thoroughly dispersed in a PAN precursor solution using a mixer such as acoustic mixer or dual-axis centrifugal speed mixer. FIG. 2 shows graphene-embedded PAN (graphene-PAN) nanofibers, demonstrating the fabrication of clean and well-defined nanofibers without significant defects or particle agglomeration.

### Dual-Fiber c-SPS-(cNP-PAN) Nanocomposite Electromembrane Fabrication

c-SPS-(cNP-PAN) dual-fiber non-woven structures are fabricated by co-electrospinning (as illustrated in FIG. 1), in which two different polymer fibers are generated simultaneously from nozzles placed at the opposite sides of a rotating grounded drum. Due to high drum rotation speeds, the two dissimilar nanofibers can distribute in close affinity to one another, eliminating microstructural segregation. In the composite membranes, PAN fibers not only serve as a cNP carrier, but also as a secondary component to adjust membrane mechanical properties. c-SPS fibers are stiff, and by introducing ductile PAN fibers, improved mechanical strength of our membranes can be achieved, which is important for water application. Thus, the ratio between the c-SPS and cNP-PAN fibers are adjusted to simultaneously adjust IEC and mechanical property of the membranes. This can be achieved by adjusting the precursor injection rates and spinning conditions of the two fiber systems. Post-spinning thermal treatment can be conducted to cure and crosslink the SPS. In addition, the thickness of c-SPS-(cNP-PAN) electromembranes can also be adjusted to balance ionic conductivity and mechanical stability of the membranes. Thinner membranes typically exhibit higher ionic conductivity due to shorter diffusion pathways for ions, but have lower mechanical stability.

FIG. 3, panel (a), shows an SEM image of polystyrene (PS)-PAN dual-fiber membranes prepared by co-electrospinning method, where thinner PAN fibers uniformly mixed with thicker PS fibers, showing a homogeneous microstructure. This structure has improved membrane mechanical strength than a simple PS or a simple PAN membrane. The porous membrane can be densified through a hot-pressing process at temperatures below polymer melting temperatures of the polymers to close the pores. An example is shown in FIG. 3, panel (b).

### Nanocomposite Electromembrane Property Characterization

Microstructure characterization of the electromembranes can be performed to characterize membrane thickness, porosity, defects, and interface roughness. Other membrane properties including water uptake, swelling degree, IEC, electrical resistance, and membrane mechanical properties such as tensile strength can be characterized by known techniques, as well.

### c-SPS-(cNP-PAN) Electromembrane ED Performance Characterization

Membrane performance can be characterized using benchtop ED cells with simulated brackish water samples (containing Na⁺, Ca²⁺, Mg²⁺ with concentrations between about 3 to about 10 g/L of each cation) and gas/oil produced water samples (containing Na⁺, K⁺, Sr²⁺, Mn²⁺, Ca²⁺, Mg²⁺ in the range of about 0.1 to about 40 g/L). ED process operating parameters (such as current density and electrolyte flow rate) and membrane performance parameters (such as ionic flux, permselectivity and recovery rate, current efficiency, energy consumption, and osmotic and electro-osmotic water transport) can be evaluated by known techniques, as well. The test results serve as feedback to guide the membrane optimization for a given application.

### Example 1. Preparation of Graphene Embedded Pan Nanofiber

Graphene embedded PAN nanofiber is an exemplary material of introducing conductive nanomaterials into PAN fibers. PAN polymer solution was prepared by dissolving 12 wt % PAN in dimethylacetamide. Graphene nanostructures with a graphene to PAN mass ratio of 8:15 were added to prepare graphene-PAN precursor solution.

The resulting solution was used for electrospinning. The precursor solution was pumped with syringe pump with a flow rate between 0.1 mL/h to 1 mL/h. The voltage was applied to the nozzle in the range of 16-26 kV. The distance from the nozzle to substrate was between 6-8 inches. During the electrospinning the relative humidity was maintained at <about 20%. Graphene embedded PAN nanofibers with well-defined fiber morphology but slightly rough surfaces were observed (FIG. 2), where the average fiber diameter was about 600 nm.

### Example 2. Preparation of rGO Embedded PVDF Membrane

rGO in a PVDF polymer matrix is another example of a conductive nanoparticle-embedded polymer nanofibers. The PVDF polymer solution was prepared by dissolving PVDF polymer in a DMF:acetone mixture. The PVDF weight percent was 16 wt %, and the ratio of DMF:acetone was 6:4. The rGO particles were ball-milled to reduce the particles size below 200 nm. The balling recipe is as follows: 3 g of coarse rGO flakes of >20 μm diameter were dispersed in 40 ml of DMF. Then, 15 g of rGO/DMF mixture and 30 g of 1 mm diameter zirconia balls were added to a ball mill jar. Ball milling was conducted at 300 rpm with 5 min on-duty and 10 min off-duty cycles for 16 h. The size-reduced rGO particles were further milled at the same ball-milling conditions with smaller size zirconia balls of 0.5 mm diameter. After this step, the smaller rGO particles were milled for another 20 h with 0.3 mm diameter zirconia balls under the same milling conditions. After ball milling, the milled rGOs were collected and dried at 80° C. overnight to remove DMF. The final particle size of rGOs was characterized by dynamic light scattering (DLS). Finally, 7 wt % rGO-PVDF solutions were prepared by adding appropriate amount of ball-milled rGO nanoparticles to PVDF solution, followed by a rGO dispersion process achieved by mixing rGO in PVDF solution with an acoustic mixer.

The resulting precursor solution was used for electrospinning. During electrospinning, the precursor solution was pumped continuously to electrospinning nozzles at a flow rate between 0.1 ml/h to 1 ml/h. The voltage applied to the nozzles was in the range of 16-26 kV. The working distance between the nozzle and the substrate was between 4-10 inches. The relative humidity was maintained <20% during the electrospinning. A porous rGO-PVDF membrane was observed by scanning electron microscopy (SEM) as shown in FIG. 3, panel (a).

To fabricate dense membranes, the electrospun porous rGO-PVDF membranes were hot-pressed at 125° C. for 10 min with a pressure of 10 metric tons. FIG. 3, panel (b) shows the SEM images of rGO-PVDF membranes after hot-pressing, where pores are closed and a dense rGO-PVDF membrane was formed.

### Examples 3. Preparation of Sulfonated Polystyrene Nanofibers

Sulfonated polystyrene (SPS) nanofibers were prepared in two steps. Step 1 involved preparation of SPS polymers by ion exchange chromatography using an SPS-based salt such as poly(styrenesulfonic acid sodium salt). The poly(styrenesulfonic acid sodium salt) was first dissolved in deionized water and then the resulting aqueous poly(styrenesulfonic acid sodium salt) solution was introduced to an ion exchange column partially filled with cation resin beads (FIG. 4). During the ion exchange process, sodium ions were extracted to the fixed negative charges on the resin beads, inducing the resin beads to give up an equivalent amount of protons (hydrogen ions). This process generated aqueous SPS acid solutions.

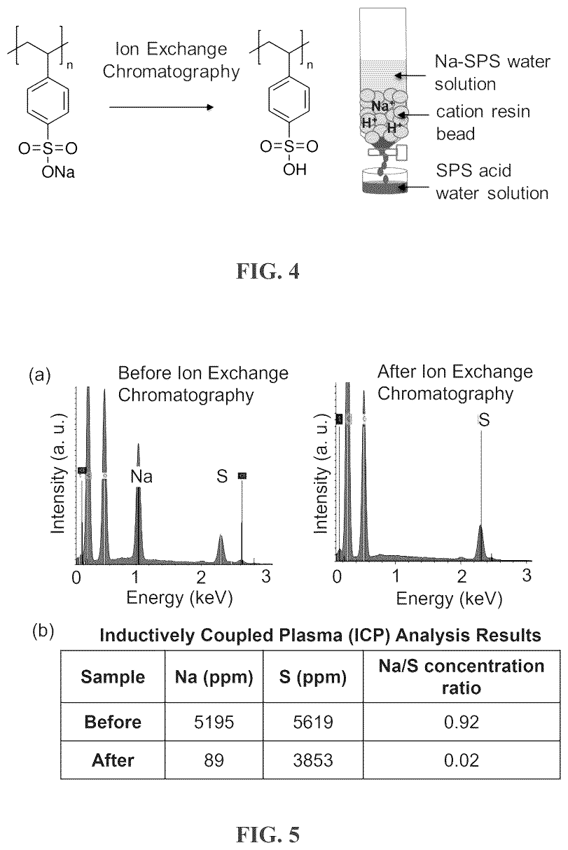

Step 2 was to prepare SPS nanofibers. The aqueous SPS acid solution was dried in an oven to evaporate water. FIG. 5, panel (a), shows the energy dispersive X-ray spectroscopy (EDX) spectrum associated with a scanning electron microscopy (SEM) image for the SPS-sodium salt and SPS acid obtained before and after ion exchange chromatography. It is apparent that the SPS-sodium sample showed a strong sodium peak at around 1 keV, which disappeared after ion exchange. This indicates that SPS-sodium salt has converted to SPS acid. Inductively coupled plasma (ICP) analysis of the SPS-sodium and SPS acid samples before and after ion exchange also confirmed that almost all the sodium has been removed after ion exchange, showing negligible sodium content in the SPS acid sample; see FIG. 5, panel (b).

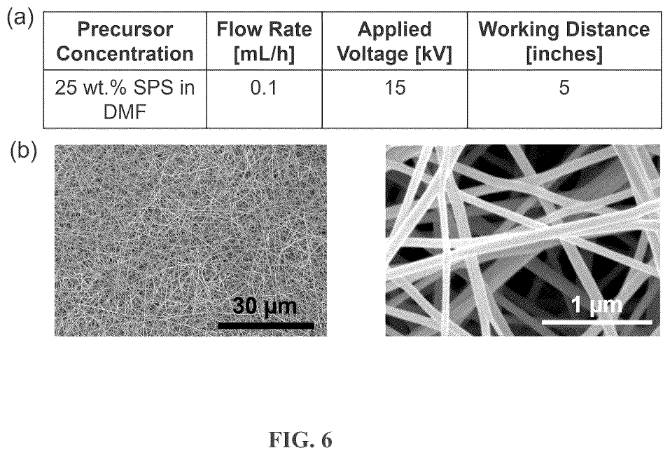

With this confirmation, SPS acid was then dissolved in dimethylformamide (DMF) to obtain electrospinning precursor solution containing about 25 wt % SPS acid in DMF. Similar to Example 1, the precursor solution was loaded into syringes and fed to an electrospinning tool to prepare SPS nanofibers at a flow rate of about 0.1 mL/h with an applied voltage of about 15 kV, at a working distance of about 5 inches. FIG. 6, panel (a), provides the electrospinning conditions in Tabular form. FIG. 6, panel (b), left image, shows the resulting electrospun SPS acid nanofibers. The right hand image in FIG. 6, panel (b), shows a higher magnification view of the same nanofibers.

### Examples 4. Preparation of Crosslinked Sulfonated Polystyrene Nanofibers

Crosslinking of SPS was conducted either using poly(ethylene oxide) (PEO) or divinylbenzene (DVB). When PEO is used as the crosslinker, PEO and SPS are dissolved in DMF solvents with at a preselected target ratio of SPS to PEO (e.g., 70 wt % SPS to 30 wt % PEO). Then, the resulting PEO-SPS DMF solution is used as an electrospinning precursor to generate PEO-SPS blended nanofibers. The as-spun fibers are dried in a vacuum oven at about 50° C. overnight to remove residual solvent. Crosslinking is conducted by thermally annealing the dry PEO-SPS blended nanofibers at about 130° C. for about 8 to about 12 hours.

When DVB is used as the crosslinker, a small amount of 2,2′-azobis(isobutyronitrile) (AIBN) is added as a catalyst, e.g., at an AIBN concentration of about 0.2 wt % to about 1 wt. % of the total polymer content. For example, a solution of SPS acid in dimethyl sulfoxide (DMSO) is mixed with a solution of DVB in DMSO at an AIBN concentration of about 5 wt %, based on the weight of SPS in a volumetric flask. The flask containing the resulting solution is purged with nitrogen for at least 15 minutes to ensure the flask contained a nitrogen atmosphere. The flask is then heated in an oil bath at about 65 to about 75° C. for about 4 to about 6 hours with continuous nitrogen gas flow to crosslink SPS with DVB. After the crosslinking process, the crosslinked SPS-DVB in DMSO solution is used for electrospinning to generate SPS-DVB nanofibers.

Any references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. An article of manufacture comprising cross-linked fluorine-free cation-conductive polymer (c-FF-CCP) fibers intertwined with electron-conductive nanoparticle-embedded hydrophilic water-insoluble polymer (cNP-HWIP) fibers.

2. The article of manufacture of claim 1, wherein the c-FF-CCP is cross-linked sulfonated polystyrene (c-SPS); and the hydrophilic water-insoluble polymer is polyacrylonitrile (PAN).

3. The article of manufacture of claim 2, wherein the c-SPS is crosslinked by one or more crosslinking agents selected from the group consisting of polyoxyethylene, poly(vinyl alcohol), and divinylbenzene.

4. The article of manufacture of claim 2, wherein the c-SPS is crosslinked by polyoxyethylene groups bonded to sulfonate groups of the sulfonated polystyrene as sulfonate esters.

5. The article of manufacture of claim 1, wherein the hydrophilic water-insoluble polymer is one or more polymer selected from the group consisting of PAN, an acrylic polymer, an epoxy polymer, polyethylene, polystyrene, polyvinylchloride, polydimethylsiloxane, a polyester, poly(2-hydroxyethyl methacrylate), a polyurethane, an amphiphilic block copolymer that contains hydrophobic and hydrophilic units, poly(N-isopropylacrylamide-co-spiropyran acrylate), a co-polymer of 2-methacryloyloxyethyl phosphorylcholine (MPC) and n-dodecyl methacrylate, a hydrogel, a three-dimensionally (3D) crosslinked polymer, and a supramolecular complex formed between a block co-polymer and a hydrogel;
wherein each hydrogel independently comprises hydrophilic polymer chains that are crosslinked either physically, chemically, or via polymerization; and
wherein the 3D crosslinked polymer optionally is selected from the group consisting of cross-linked gum Arabic, cross-linked PEG, cross-linked hydroxyethyl cellulose, cross-linked carboxymethyl cellulose, cross-linked hydroxypropyl methylcellulose, cross-linked hydroxypropyl cellulose, cross-linked starch, cross-linked PVA, cross-linked sterculia gum, cross-linked polyacrylamide, and cross-linked chitosan; and the supramolecular complex formed between a block co-polymer and a hydrogel optionally is a supramolecular complex of poly(N-vinylpyrrolidone)-b-poly(oligo ethylene glycol methacrylate) combined with alpha-cyclodextrin (α-CD).

6. The article of manufacture of claim 1, wherein the c-FF-CCP is selected from the group consisting of c-SPS and an ionic conductive salt-containing cross-linked PEO;
wherein the ionic conductive salt-containing cross-linked PEO optionally is methacrylate-appended PEO comprising a salt selected from the group consisting of sodium pentacyanopropenide (NaPCPI), sodium 2,3,4,5-tetracyanopirolate (NaTCP), sodium 2,4,5-tricyanoimidazolate (NaTIM), and a potassium ion source; and wherein the potassium ion source optionally is KBPh₄.

7. The article of manufacture of claim 1, wherein the electron-conductive nanoparticles comprise one or more nanoparticle material selected from the group consisting of graphene, reduced graphene oxide, biochar, graphite, conductive carbon, carbon nanotubes, and MXene.

8. The article of manufacture of claim 1, wherein the cNP-HWIP fibers comprise about 1 to about 40 percent by weight (wt %) of the conductive nanoparticles embedded therein, based on the weight of the hydrophilic water-insoluble polymer.

9. The article of manufacture of claim 1, wherein the c-FF-CCP fibers and the cNP-HWIP fibers are formed and intertwined by simultaneously electrospinning the fibers from separate polymer solutions comprising (a) a fluorine-free cation-conductive polymer and a cross-linking agent, and (b) a hydrophilic water-insoluble polymer and conductive nanoparticles; the solutions being simultaneously electrospun through separate electrospinning nozzles onto a revolving grounded or negatively charged drum; followed by crosslinking the fluorine-free cation-conductive polymer with the included crosslinking agent.

10. The article of manufacture of claim 1, wherein the c-FF-CCP fibers have an average fiber diameter in the range of about 0.05 μm to about 10 μm.

11. The article of manufacture of claim 1, wherein the cNP-HWIP fibers have an average fiber diameter in the range of about 0.05 μm to about 10 μm.

12. The article of manufacture of claim 1, having a respective weight ratio of the c-FF-CCP fibers to the cNP-HWIP fibers of about 95:5 to about 50:50.

13. An ion-exchange membrane comprising the article of manufacture of claim 1, wherein the c-FF-CCP fibers and the cNP-HWIP fibers are fused together to form a dense ion-exchange membrane.

14. The ion-exchange membrane of claim 13, wherein the dense ion-exchange membrane has a thickness in the range of about 5 μm to about 500 μm.

15. The ion-exchange membrane of claim 13, wherein the c-FF-CCP fibers are c-SPS fibers that are crosslinked by one or more crosslinking agent selected from the group consisting of polyoxyethylene, poly(vinyl alcohol), and divinylbenzene.

16. The ion-exchange membrane of claim 15, wherein the c-SPS fibers are crosslinked by polyoxyethylene groups bonded to sulfonate groups of the sulfonated polystyrene as sulfonate esters.

17. The ion-exchange membrane of claim 13, wherein the c-FF-CCP is selected from the group consisting of c-SPS and an ionic conductive salt-containing cross-linked PEO.

18. The ion-exchange membrane of claim 17, wherein the ionic conductive salt-containing cross-linked PEO is poly(ethylene glycol) methacrylate-appended PEO comprising a salt selected from the group consisting of sodium pentacyanopropenide (NaPCPI), sodium 2,3,4,5-tetracyanopirolate (NaTCP), sodium 2,4,5-tricyanoimidazolate (NaTIM), and a potassium ion source; and wherein the potassium ion source optionally is KBPh₄.

19. The ion-exchange membrane of claim 13, wherein conductive nanoparticles comprise one or more nanoparticle material selected from the group consisting of graphene, reduced graphene oxide, biochar, graphite, conductive carbon, carbon nanotubes, and MXene.

20. The ion-exchange membrane of claim 13, wherein the c-FF-CCP fibers and the cNP-HWIP fibers are formed and intertwined by simultaneously electrospinning the fibers together in a solvent onto a grounded or negatively charged revolving drum.

21. The ion-exchange membrane of claim 13, wherein the c-FF-CCP fibers have an average fiber diameter in the range of about 0.05 μm to about 10 μm.

22. The ion-exchange membrane of claim 13, wherein the cNP-HWIP fibers have an average fiber diameter in the range of about 0.05 μm to about 10 μm.

23. The ion-exchange membrane of claim 13, wherein the cNP-HWIP fibers comprise about 1 to about 40 percent by weight of the conductive nanoparticles embedded therein, based on the weight of the hydrophilic water-insoluble polymer.

24. The ion-exchange membrane of claim 13, having a respective weight ratio of the c-FF-CCP fibers to the cNP-HWIP fibers of about 95:5 to about 50:50.

25. A method of preparing the ion-exchange membrane of claim 13, comprising:
(a) simultaneously and separately electrospinning a first solution of a fluorine-free cation-conductive polymer and a crosslinking agent, and a second solution of electron-conductive nanoparticles and a hydrophilic water-insoluble polymer, onto a grounded or negatively charged drum from separate nozzles on opposite sides of the drum, to generate an intertwined mixture of fluorine-free cation-conductive polymer fibers and hydrophilic water-insoluble polymer fibers embedded with the conductive nanoparticles;
(b) reacting the fluorine-free cation-conductive polymer with the crosslinking agent within the fluorine-free cation-conductive polymer fibers to form the c-FF-CCP fibers;
(c) recovering the so-formed intertwined c-FF-CCP fibers and the cNP-HWIP fibers from the substrate; and
(d) hot-pressing the intertwined fibers from step (c) into a dense membrane.
